(19) United States
(12) Patent Application Publication
(10) Pub. No.: US 2008/0270845 A1
(43) Pub. Date: Oct. 30, 2008

(54) Methods and Apparatus That Enable a Viewer to Distinguish Different Test Data Entries and Test Data Items

(76) Inventors: Kristin Petersen, Clifton Park, NY (US); Carli Connally, Fort Collins, CO (US); Laura Bundy, Fort Collins, CO (US)

Correspondence Address: Gregory W. Osterloth;Holland & Hart, LLP, P.O. Box 8749, Denver, CO, 80201, US

(21) Appl. No.: 11/740,758

(22) Filed: Apr. 26, 2007

(51) Int. Cl. G06F 11/34; G07F 11/00

(52) U.S. Cl. 714/45; 714/46

(57) ABSTRACT

In one embodiment, a plurality of test data entries are displayed via a graphical user interface (GUI). Each of the test data entries includes at least one dynamic data item that depends on an execution of at least one test for a device under test, and at least one contextual data item that provides a context for the at least one test. The dynamic data items of the test data entries are displayed using a first color scheme. The contextual data items of the test data entries are displayed using a second color scheme that differs from the first color scheme, thereby enabling a viewer to more easily distinguish the dynamic data items from the contextual data items. Other embodiments are also disclosed.

### BACKGROUND

When testing circuit devices such as system-on-a-chip (SOC) devices, acquired test data is often displayed in a monochrome format (e.g., in black and white, or in gray and white). However, displaying test data in a monochrome format makes it difficult for a viewer to identify test data of interest.

In some cases, acquired test data is displayed in a format that distinguishes results of failed tests from results of passed tests. For example, results of passed test results may be highlighted in green, or results of failed tests may be highlighted in red. However, this sort of display format may also fail to bring important test data to a viewer's attention.

### BRIEF DESCRIPTION OF THE DRAWINGS

Illustrative embodiments of the invention are illustrated in the drawings, in which:

FIG. 1 illustrates a first exemplary method that enables a viewer to distinguish different test data entries and test data items;

FIG. 2 illustrates a second exemplary method that enables a viewer to distinguish different test data entries and test data items;

FIG. 3 illustrates an exemplary graphical user interface (GUI) that implements the methods shown in FIGS. 1 & 2; and

FIG. 4 illustrates a test statistics window of the GUI shown in FIG. 3.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

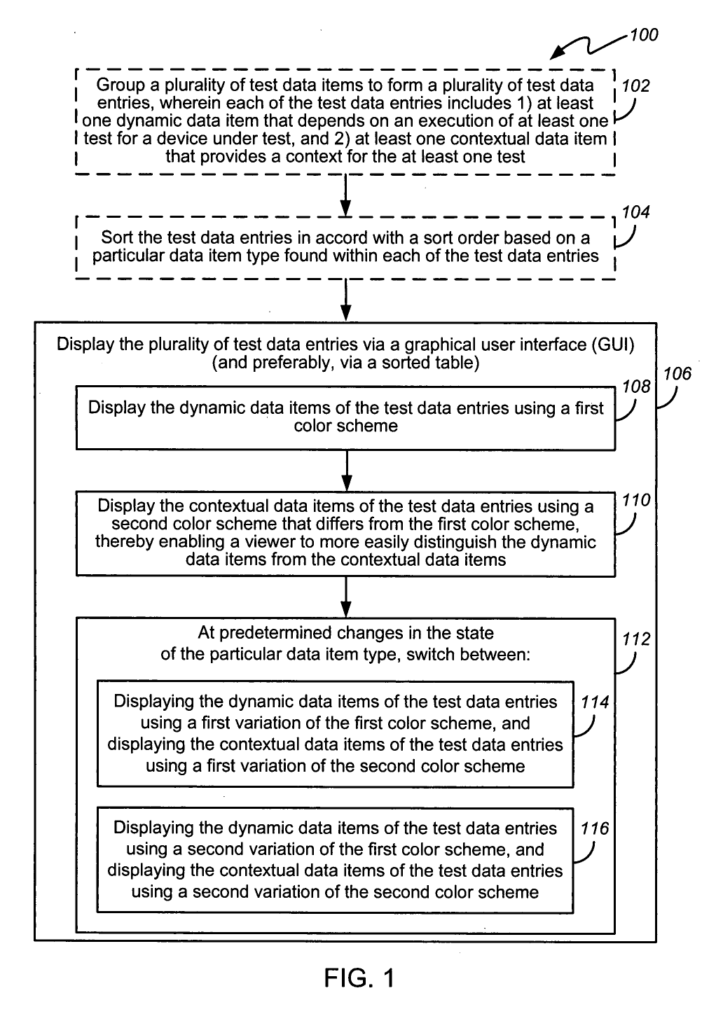

In accord with one embodiment of the invention, FIG. 1 illustrates a computer-implemented method 100 in which a plurality of test data entries are displayed via a graphical user interface (GUI). See, block 106. Each of the test data entries includes a plurality of test data items, including 1) at least one dynamic data item that depends on an execution of at least one test for a device under test (DUT), and 2) at least one contextual data item that provides a context for the at least one test. The dynamic data items are displayed using a first color scheme, and the contextual data items are displayed using a second color scheme, where the second color scheme is different from the first color scheme. See, blocks 108, 110. By way of example, displaying the dynamic data items using a first color scheme may comprise 1) displaying ones of the dynamic data items representing passed tests with a yellow background, and/or 2) displaying ones of the dynamic data items representing failed tests with a red background. Similarly, and by way of example, displaying the contextual data items using a second color scheme may comprise displaying the contextual data items with a gray background. In any event, the display of dynamic and contextual data items using different color schemes enables a viewer to more easily distinguish the dynamic data items from the contextual data items.

In one embodiment of the method 100, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the U.S. patent application of Connally, et al. entitled “Apparatus for Storing and Formatting Data” (Ser. No. 11/345,040). By way of example, a dynamic data item may take the form of a test result, or a statistic that depends on the execution of multiple tests for a DUT. A contextual data item may, for example, take the form of a test result identifier (e.g., a test name or test number) or a test limit.

In one embodiment of the method 100, the method 100 may comprise the step of grouping a plurality of test data items to form the plurality of test data entries. See, block 102. During or after (and preferably during) the formation of the test data entries, the test data entries may be sorted in accord with a sort order based on a particular data item type found within each of the test data entries (block 104), and the sorted test data entries may be displayed via a sorted table of the GUI (block 106). In one embodiment, a dynamically updated range of the sorted test data entries may be displayed via the sorted table.

At predetermined changes in the state of the particular data item type in the sorted table (block 112), the method 100 may switch between 1) displaying the dynamic data items of the test data entries using a first variation of the first color scheme, and displaying the contextual data items of the test data entries using a first variation of the second color scheme (block 114), and 2) displaying the dynamic data items of the test data entries using a second variation of the first color scheme, and displaying the contextual data items of the test data entries using a second variation of the second color scheme (block 116). By way of example, displaying the dynamic data items using first and second variations of the first color scheme may comprise, respectively, displaying ones of the dynamic data items representing passed tests with first and second shades (e.g., darker and lighter shades) of a yellow background. Similarly, and by further way of example, displaying the contextual data items using first and second variations of the second color scheme may comprise, respectively, displaying the contextual data items with first and second shades (e.g., darker and lighter shades) of a gray background.

By displaying test data entries differently, depending on changes in the state of a particular data item type, a viewer can more easily distinguish changes in the state of the particular data item type. In one embodiment, the switching 112, 114, 116 may be initiated every time there is a change in the state of the particular data item type. In other embodiments, the switching 112, 114, 116 may only be initiated after particular types of state changes (e.g., a state change that results in a numerical value crossing into a new range, or a state change that results in a change in the first letter of a test name).

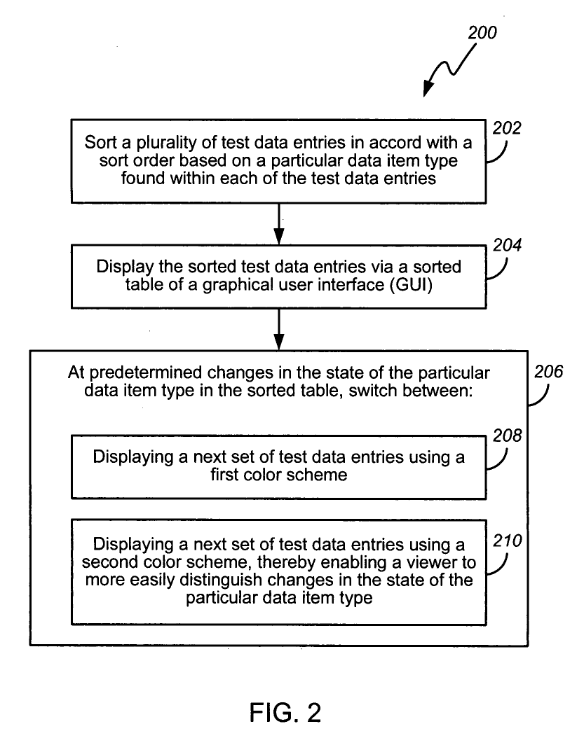

In some cases, there may not be a need or desire to distinguish dynamic data items from contextual data items. FIG. 2 therefore illustrates another embodiment of the invention. In accord with the computer-implemented method 200, a plurality of test data entries are sorted in accord with a sort order, with the sort order being based on a particular data item type found within each of the test data entries (block 202). The sorted test data entries are then displayed via a sorted table of a GUI (block 204), and at predetermined changes in the state of the particular data item type in the sorted table (block 206), the method 200 switches between 1) displaying a next set of test data entries using a first color scheme (block 208), and 2) displaying a next set of test data entries using a second color scheme, thereby enabling a viewer to more easily distinguish changes in the state of the particular data item type (block 210). By way of example, displaying test data entries using a first color scheme may comprise displaying particular types of test data items in the test data entries with a background having a first shade; and displaying test data entries using a second color scheme may comprise displaying particular types of test data items in the test data entries with a background having a second shade, where the second shade is darker than the first shade.

In both the expanded method 100 (including blocks 102, 104, 112, 114 and 116) and the method 200, the particular data item type that serves as a basis for sorting a plurality of test data entries may take various forms, including: a dynamic data item type,-such as a type of test result; or a contextual data item type, such as a type of test result identifier.

Of note, the steps of the methods 100, 200 may take orders other steps be performed repetitively, and substantially in parallel.

The methods 100, 200 shown in FIGS. 1 & 2 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

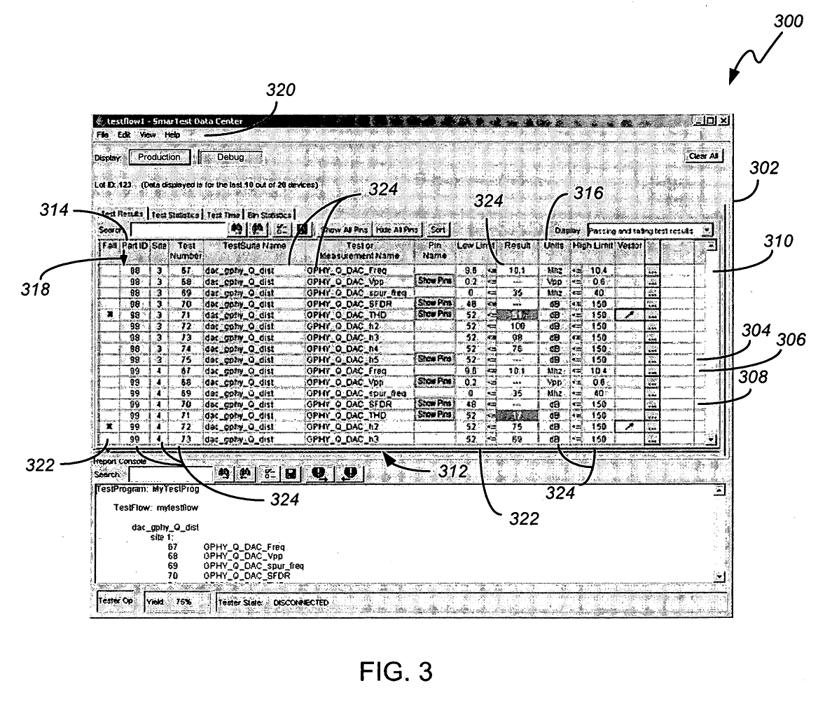

FIG. 3 illustrates an exemplary window (or screen) 302 of a GUI 300 via which the methods 100, 200 may be implemented. As shown, a plurality of test data entries 304, 306, 308 composed of various test data items (such as a “Test Number” and a “Result”) are displayed via the window 302. By way of example, each test data entry 304, 306, 308 comprises three test result identifiers, including: a “Test Number”, a “Test or Measurement Name”, and a “TestSuite Name” that identifies a test suite to which the test name and number belong. In addition, each test data entry 304, 306, 308 comprises: information identifying the test resources via which a test result was acquired (e.g., a test “Site” number), and information identifying the device and pin for which a test result was acquired (e.g., a device “Part ID”, and a device “Pin Name”). Each test data entry 304, 306, 308 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated. In the context of method 100, all of the data items in the test data entries 304, 306, 308 are considered “contextual data items”, but for the data items presented in the “Result” and “Fail” columns, which are considered “dynamic data items”.

In accord with the method 100, the dynamic data items 322 in the window 302 (i.e., those items appearing in the “Result” and “Fail” columns) are displayed using a first color scheme. Features of the first color scheme are 1) the display of ones of the dynamic data items 322 representing passed tests on yellow backgrounds (e.g., yellow table cell backgrounds), and 2) the display of ones of the dynamic data items 322 representing failed tests on red backgrounds (e.g., red table cell backgrounds). The contextual data items 324 in the window 302 (e.g., those items appearing in the “Part ID”, “Site”, “Test Number”, “TestSuite Name”, “Test or Measurement Name”, “Pin Name”, “Low Limit”, “Units”, “High Limit” and “Vector” columns) are displayed using a second color scheme. A feature of the second color scheme is the display of the contextual data items 324 on gray backgrounds.

Preferably, the window 302 is displayed during execution of a plurality of tests on which the test data entries 304, 306, 308 are based (i.e., during test of a DUT). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 302 (i.e., not in real-time). Typically, the test data entries 304, 306, 308 that are displayed at any one time represent only some of the test data entries or items that are generated during execution of a plurality of tests. One or more mechanisms such as a scroll bar 310 may be provided to allow a user to navigate to different test data entries or items.

As further shown in FIG. 3, each of the test data entries 304, 306, 308 is displayed as a line of a sorted table 312, with different lines of the table corresponding to different ones of the test data entries 304, 306, 308. For purposes of this description, a “table” is defined to be either an integrated structure wherein data is displayed in tabular form, or multiple structures that, when displayed side-by-side, enable a user to review information in rows and columns.

Each of the columns in the table 312 includes a column header, such as the header 314 or the header 316. In one embodiment of the GUI 300, each of the column headers 314, 316 serves as a sort mechanism, and a user's graphical selection of (e.g., click on) one of the headers 314, 316 initiates a re-sort of the test data entries 304, 306, 308, in accord with a particular data item type referenced by the selected header. In FIG. 3, the test data entries 304, 306, 308 are shown to be primarily sorted by the test data items appearing under the “Part ID” header 314 of the table 312. The test data entries 304, 306, 308 shown in FIG. 3 are also sorted, on secondary bases, in accord with test data items appearing under other headers.

In the GUI 300 (FIG. 3), and at predetermined changes in the state of the data item type that dictates the primary sort order for the data entries 304, 306, 308 of the table 312, the shades of the background colors (i.e., yellow or gray) applied to the data entries 304, 306, 308 switch between a first shade (i.e., dark yellow and gray) and a second shade (i.e., light yellow and gray). In this manner, a viewer can more easily distinguish changes in the state of the data item type.

Although FIG. 3 shows one possible sort order for the test data entries 304, 306, 308 of the table 312, other sort orders are possible. For example, test data entries 304, 306, 308 could be sorted by any test data item that includes a test result, such as a pass/fail indication (e.g., those test data items that appear in the “Fail” field of table 312) or a test measurement (e.g., those test data items that appear in the “Result” field of table 312). The test data entries 304, 306, 308 could also be sorted by any test data item that includes a test result identifier, such as a test number (e.g., those test data items that appear in the “Test Number” field of table 312) or test name (e.g., those test data items that appear in the “Test or Measurement Name” field of table 312). Sort orders may also be based on other types of test data items that are capable of being parsed and sorted.

In the absence of user input via a sort mechanism (e.g., one of the headers 314, 316), the test data entries 304, 306, 308 may be sorted chronologically, or according to some other default sort order.

In FIG. 3, the primary sort order for the test data entries 304, 306, 308 is indicated by an arrow 318 appearing in the table's header 314. The direction of the arrow 318 indicates whether the sort order is ascending or descending, and by clicking on an already selected header, the direction of the sort order can be changed.

Instead of, or in addition to, implementing a sort mechanism as a column header, a GUI 300 could provide other kinds of sort mechanisms. For example, a GUI 300 could implement a sort mechanism as a menu item that is obtained, for example, by 1) right-clicking on the table 312 to obtain a pop-up menu of test data items via which the test data entries 304, 306, 308 may be sorted, or by 2) launching a drop-down menu of test data items via which the test data entries 304, 306, 308 may be sorted (e.g., from a menu bar 320).

If a user highlights or otherwise selects a particular one of the test data entries 304, 306, 308, the table 312 may be “parked” about the particular test data entry. However, if a newly formed test data entry falls within a currently displayed range about the particular test data entry, the displayed range may be dynamically updated to include the newly formed test data entry. In the absence of a user selecting a particular one of the test data entries 304, 306, 308, the range of test data entries 304, 306, 308 displayed in the table 312 may be dynamically updated to include a most recently formed one (or ones) of the test data entries.

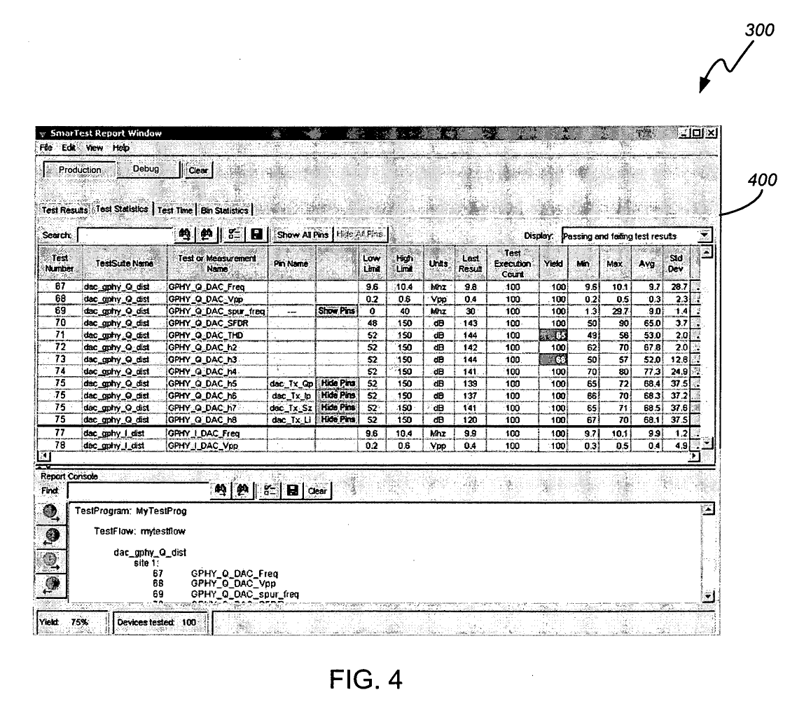

FIG. 4 illustrates application of the method 100 to a “Test Statistics” window 400 of the GUI 300. In this example, the dynamic data items comprise those items that appear in the “Yield”, “Min”, “Max”, “Avg” and “Std Dev” columns, and the contextual data items comprise those items that appear in the “Test Number”, “TestSuite Name”, “Test or Measurement Name”, “Pin Name”, “Low Limit”, “High Limit”, “Units”, “Last Result” and “Test Execution Count” columns. Similarly to the data items shown in FIG. 3, the dynamic data items are displayed with a yellow background, and the contextual data items are displayed with a gray background.

In FIGS. 3 & 4, graphical mechanisms for launching the display of additional test data items are embedded within some of the displayed test data entries. For example, the test data entries 304, 306, 308 shown in FIG. 3 comprise buttons labeled with arrows (in the “Vector” column) or buttons labeled with ellipses. These buttons can be used to launch the display of vector or other test data. In FIGS. 3 & 4, additional buttons are provided with the labels “Show Pins” or “Hide Pins”. These buttons can be used to show or hide detailed pin data for a test. Although all of these buttons may be used to access dynamic test data, the buttons themselves (and the labels thereon) do not display dynamic test data. As a result, these buttons are displayed using the same color scheme used to display contextual data items.

What is claimed is:

1. A computer-implemented method, comprising:
displaying a plurality of test data entries via a graphical user interface (GUI), wherein each of the test data entries includes i) at least one dynamic data item that depends on an execution of at least one test for a device under test, and ii) at least one contextual data item that provides a context for the at least one test;
displaying the dynamic data items of the test data entries using a first color scheme; and
displaying the contextual data items of the test data entries using a second color scheme that differs from the first color scheme, thereby enabling a viewer to more easily distinguish the dynamic data items from the contextual data items.

2. The method of claim 1, wherein the at least one dynamic data item of each test data entry comprises a test result.

3. The method of claim 1, wherein the at least one dynamic data item of each test data entry comprises a statistic that depends on an execution of multiple tests for a device under test.

4. The method of claim 1, wherein the at least one contextual data item of each test data entry comprises a test result identifier.

5. The method of claim 1, wherein the at least one contextual data item of each test data entry comprises one or more test limits.

6. The method of claim 1, wherein at least one of the test data entries includes at least one graphical mechanism for launching a display of additional test data items, and wherein the method further comprises displaying the at least one graphical mechanism using the second color scheme.

7. The method of claim 1, wherein:
displaying the dynamic data items using the first color scheme comprises displaying ones of the dynamic data items representing passed tests with a yellow background; and
displaying the contextual data items using the second color scheme comprises displaying the contextual data items with a gray background.

8. The method of claim 7, wherein displaying the dynamic data items using the first color scheme comprises displaying ones of the dynamic data items representing failed tests with a red background.

9. The method of claim 1, further comprising:
sorting the test data entries in accord with a sort order based on a particular data item type found within each of the test data entries;
displaying the sorted test data entries via a sorted table of the GUI; and
at predetermined changes in the state of the particular data item type in the sorted table, switching between i) displaying the dynamic data items of the test data entries using a first variation of the first color scheme, and displaying the contextual data items of the test data entries using a first variation of the second color scheme, and ii) displaying the dynamic data items of the test data entries using a second variation of the first color scheme, and displaying the contextual data items of the test data entries using a second variation of the second color scheme.

10. The method of claim 9, wherein:
displaying the dynamic data items using the first and second variations of the first color scheme comprises displaying ones of the dynamic data items representing passed tests with first and second shades of a yellow background; and
displaying the contextual data items using the first and second variations of the second color scheme comprises displaying the contextual data items with first and second shades of a gray background.

11. The method of claim 9, further comprising:
providing, via the GUI, at least one sort mechanism that enables a user to change the particular data item type on which the sort order is based.

12. The method of claim 1, further comprising:
grouping a plurality of test data items to form the plurality of test data entries.

13. A computer-implemented method, comprising:
sorting a plurality of test data entries in accord with a sort order based on a particular data item type found within each of the test data entries;
displaying the sorted test data entries via a sorted table of a graphical user interface (GUI); and
at predetermined changes in the state of the particular data item type in the sorted table, switching between i) displaying a next set of test data entries using a first color scheme, and ii) displaying a next set of test data entries using a second color scheme, thereby enabling a viewer to more easily distinguish changes in the state of the particular data item type.

14. The method of claim 13, wherein each of the test data entries includes a test result and a test result identifier.

15. The method of claim 13, wherein:
displaying the next set of test data entries using the first color scheme comprises displaying particular types of test data items in the test data entries with a background having a first shade; and
displaying the next set of test data entries using the second color scheme comprises displaying particular types of test data items in the test data entries with a background having a second shade, wherein the second shade is darker than the first shade.

16. The method of claim 13, further comprising:
providing, via the GUI, at least one sort mechanism that enables a user to change the particular data item type on which the sort order is based.

17. The method of claim 13, wherein displaying the sorted test data entries via the sorted table comprises displaying a dynamically updated range of the sorted test data entries.

18. Apparatus, comprising:
computer-readable media;
computer-readable code, stored on the computer-readable media, including,
code to cause a computer to display a plurality of test data entries via a graphical user interface (GUI), wherein each of the test data entries includes i) at least one dynamic data item that depends on an execution of at least one test for a device under test, and ii) at least one contextual data item that provides a context for the at least one test;
code to cause the computer to display the dynamic data items of the test data entries using a first color scheme; and
code to cause the computer to display the contextual data items of the test data entries using a second color scheme that differs from the first color scheme, thereby enabling a viewer to more easily distinguish the dynamic data items from the contextual data items.

19. The apparatus of claim 18, wherein the at least one dynamic data item of each test data entry comprises a test result.

20. The apparatus of claim 18, wherein:
the code to cause the computer to display the dynamic data items using the first color scheme comprises code to cause the computer to display ones of the dynamic data items representing passed tests with a yellow background; and
the code to cause the computer to display the contextual data items using the second color scheme comprises code to cause the computer to display the contextual data items with a gray background.

21. The apparatus of claim 20, wherein displaying the dynamic data items using the first color scheme comprises displaying ones of the dynamic data items representing failed tests with a red background.

22. Apparatus, comprising:
computer-readable media;
computer-readable code, stored on the computer-readable media, including,
code to cause a computer to sort a plurality of test data entries in accord with a sort order based on a particular data item type found within each of the test data entries;
code to cause the computer to display the sorted test data entries via a sorted table of a graphical user interface (GUI); and
code to cause the computer to, at predetermined changes in the state of the particular data item type in the sorted table, switch between i) displaying a next set of test data entries using a first color scheme, and ii) displaying a next set of test data entries using a second color scheme, thereby enabling a viewer to more easily distinguish changes in the state of the particular data item type.

23. The apparatus of claim 22, wherein each of the test data entries includes a test result and a test result identifier.

24. The apparatus of claim 22, wherein:
the code to cause the computer to display the next set of test data entries using the first color scheme comprises code to cause the computer to display test data items with a background having a first shade; and
the code to cause the computer to display the next set of test data entries using the second color scheme comprises code to cause the computer to display test data items with a background having a second shade, wherein the second shade is darker than the first shade.
